(19) United States
(12) Patent Application Publication
(10) Pub. No.: US 2005/0218362 A1
(43) Pub. Date: Oct. 6, 2005

(54) Linear solenoid valve

(75) Inventors: Hideki Furuta, Kakuda-shi (JP); Shigeto Ryuen, Sendai-shi (JP); Hidetoshi Watanabe, Shibata-gun (JP); Satoshi Noda, Sendai-shi (JP)

Correspondence Address: LAHIVE & COCKFIELD, LLP., 28 STATE STREET, BOSTON, MA, 02109, US

(73) Assignee: Keihin Corporation, Shinjuku-Ku (JP)

(21) Appl. No.: 11/089,876

(22) Filed: Mar. 24, 2005

(30) Foreign Application Priority Data
Mar. 30, 2004 (JP) 2004-100955
Mar. 30, 2004 (JP) 2004-100977

(51) Int. Cl. F16K 31/02

(52) U.S. Cl. 251/129.15

(57) ABSTRACT

A housing has a flat outer end face contiguous to the base of a protrusion on the housing. A movable core has an end face facing said protrusion and lying flush with the flat outer end face of the housing. Alternatively, the end face of the movable core may project beyond the flat outer end face of the housing toward the protrusion.

### BACKGROUND OF THE INVENTION

1. Field of the Invention

The present invention relates to a linear solenoid valve for generating an electromagnetic force in proportion to an amount of current supplied to a solenoid and displacing a valve element under the generated electromagnetic force.

2. Description of the Related Art

There have been used in the art electromagnetic valves for displacing a valve element by attracting a movable core to a fixed core under an electromagnetic force that is generated when a solenoid coil is energized.

The applicant of the present application has proposed an electromagnetic apparatus, as such an electromagnetic valve, which has a movable core capable of accurately responding to magnetic forces applied thereto.

### SUMMARY OF THE INVENTION

It is a general object of the present invention to provide a linear solenoid valve which is capable of applying an increased attractive force to a movable core by setting a positional relationship at which a side surface of the movable core and an inner wall surface of a housing overlap each other.

Another object of the present invention is to provide a linear solenoid valve, which is capable of applying an increased attractive force to a movable core, by setting a layout relationship between an annular flange of a fixed core and a coil stack mounted on a coil bobbin.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a longitudinal cross-sectional view of a hydraulic control valve according to an embodiment of the present invention, taken along an axial direction thereof;

FIG. 2 is a longitudinal cross-sectional view of the hydraulic control valve, showing a spool valve displaced when a solenoid of the hydraulic control valve shown in FIG. 1 is energized;

FIG. 3 is an enlarged fragmentary longitudinal cross-sectional view of a coil assembly of the hydraulic control valve shown in FIG. 1;

FIG. 4 is an enlarged fragmentary longitudinal cross-sectional view showing a rounded portion of arcuate cross section, which is formed in a joint region between the bottom of a housing and a yoke;

FIG. 5 is an enlarged fragmentary longitudinal cross-sectional view of a coil including a wire having a square cross section which is wound around a coil bobbin;

FIG. 6 is an enlarged fragmentary longitudinal cross-sectional view of a coil that is wound around a coil bobbin, and which is free of a flange;

FIG. 7 is an enlarged fragmentary longitudinal cross-sectional view of a modification of the coil assembly shown in FIG. 3;

FIG. 8 is an enlarged fragmentary longitudinal cross-sectional view of a coil including a wire having an elongate rectangular cross section, which is wound around a coil bobbin;

FIG. 9 is an enlarged fragmentary longitudinal cross-sectional view showing a movable core, which has an end projecting a distance ΔT outwardly beyond an end face of a housing;

FIG. 10 is an enlarged fragmentary view showing a magnetic circuit of a solenoid;

FIG. 11 is an enlarged fragmentary view showing magnetic fluxes flowing through a tapered portion, which is formed in a joint region between the bottom of a housing and a yoke;

FIG. 12 is an enlarged fragmentary view showing magnetic fluxes flowing through a right-angled or corner portion, according to a comparative example;

FIG. 13 is a diagram showing the relationship between the thrust force on a movable core and the stroke thereof; and

FIG. 14 is an enlarged fragmentary longitudinal cross-sectional view of a conventional coil wound around a coil bobbin.

### DESCRIPTION OF THE PREFERRED EMBODIMENTS

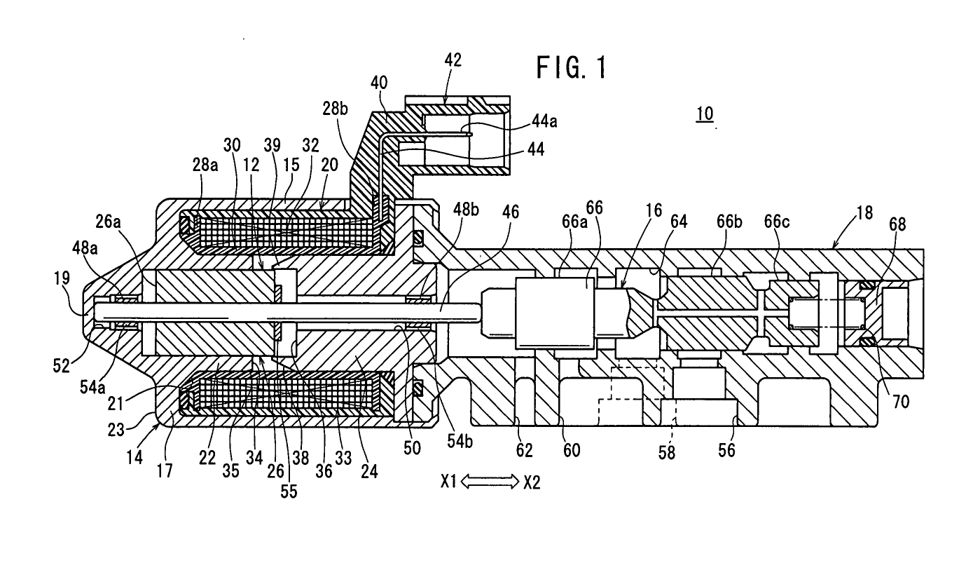

FIG. 1 shows in longitudinal cross section a hydraulic control valve 10 according to an embodiment of the present invention.

As shown in FIG. 1, the hydraulic control valve 10 comprises a housing 14 with a solenoid (linear solenoid) 12 disposed therein and a valve body 18 integrally coupled to the housing 14 and accommodating a valve mechanism 16 therein. The housing 14 and the valve body 18 jointly function as a valve casing. The housing 14 is in the form of a bottomed hollow cylinder made of a magnetic material such as SUM (JIS) or the like.

The housing 14 comprises an outer hollow cylindrical member 15, a tubular yoke 22 disposed in and spaced radially inwardly a predetermined distance from the hollow cylindrical member 15, the yoke 22 extending substantially parallel to the hollow cylindrical member 15, a bottom 17 which is thicker than the hollow cylindrical member 15 and joins the left ends of the hollow cylindrical member 15 and the yoke 22, and a mountain-shaped protrusion 19 contiguous to the bottom 17 and projecting a predetermined distance outwardly from the bottom 17 in an axial direction of the housing 14. The hollow cylindrical member 15, the yoke 22, the bottom 17, and the protrusion 19 are formed integrally with each other. The tubular yoke 22 may be a substantially tubular member (not shown) separate from the housing 14 and having an axial end press-fitted and held by a press-fitting surface (not shown) on an inner circumferential surface of the bottom 17 of the housing 14.

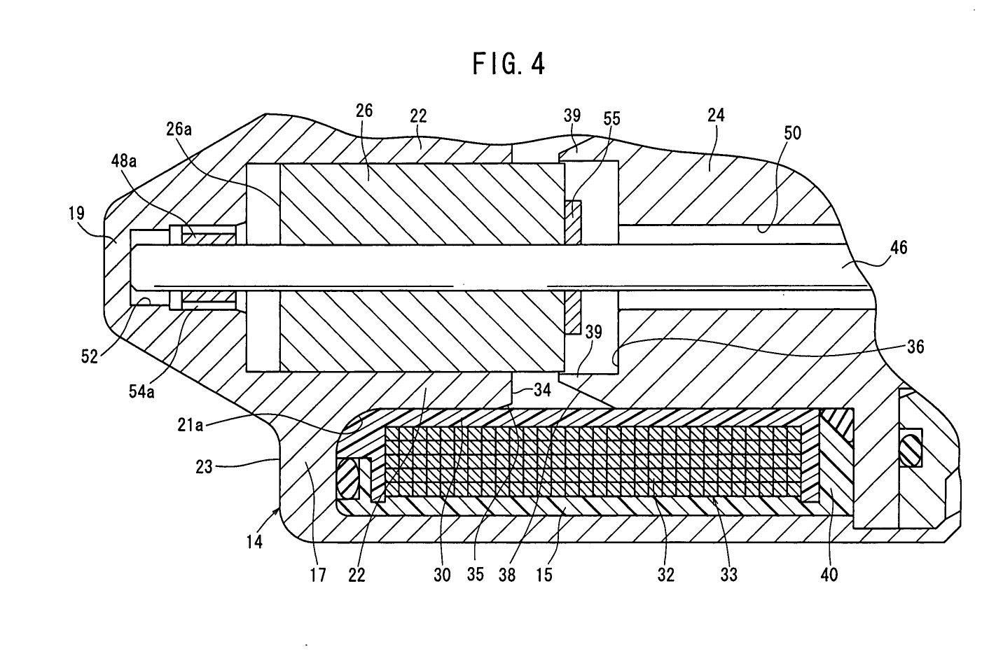

The housing 14 has a tapered portion 21 on an inner wall thereof across which the outer hollow cylindrical member 15 and the inner yoke 22 radially confront each other. The tapered portion 21 has a slanted surface which is inclined a predetermined angle from the bottom 17 toward the yoke 22, and which is progressively smaller in diameter from the bottom 17 toward the yoke 22. As shown in FIG. 4, the tapered portion 21 may be replaced with a rounded portion 21a of arcuate cross section, which has a predetermined radius of curvature.

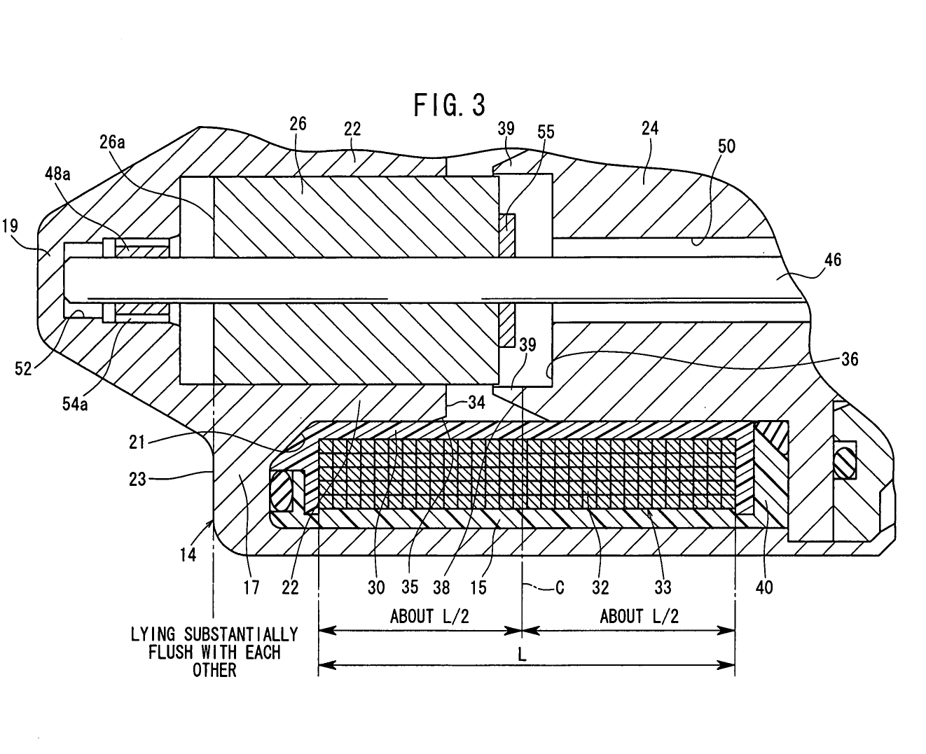

The protrusion 19 has a hole 52 defined centrally therein, which is open inwardly to receive an end of a shaft 46 (described later). The housing 14 has a flat end face 23 contiguous to the base of the protrusion 19. As shown in FIG. 3, the end face 23 of the housing 14 lies substantially flush with an end face 26a of a movable core 26 (described later) that faces the protrusion 19.

The solenoid 12 includes a coil assembly 20 disposed in the housing 14, the tubular yoke 22 being formed integrally with the housing 14 at the closed end thereof and disposed in the coil assembly 20, a fixed core 24 joined to an open end of the housing 14 and axially spaced a predetermined clearance from the yoke 22 within the coil assembly 20, and the movable core 26, which is slidably fitted in both the yoke 22 and the fixed core 24.

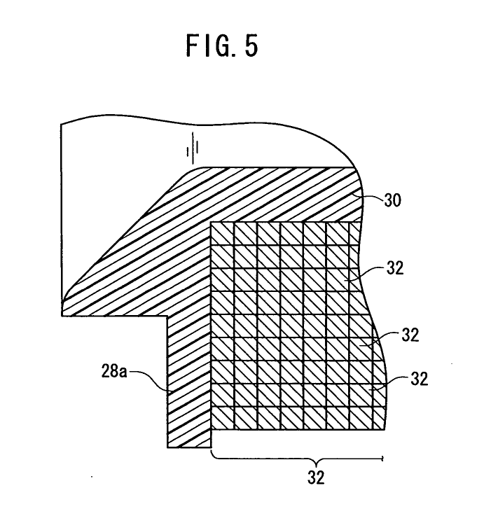

The coil assembly 20 comprises a coil bobbin 30 made of a plastic material and having flanges 28a, 28b disposed on respective axially spaced ends thereof, and a coil 32 having a plurality of turns wound around the coil bobbin 30 and comprising a conductive wire having a square cross section, as shown in FIGS. 3 through 5.

The coil 32 has a plurality of coil layers stacked on the coil bobbin 30 in a shape having a substantially elongate rectangular cross section. The stacked coil layers will be referred to as a coil stack 33 when described in detail below.

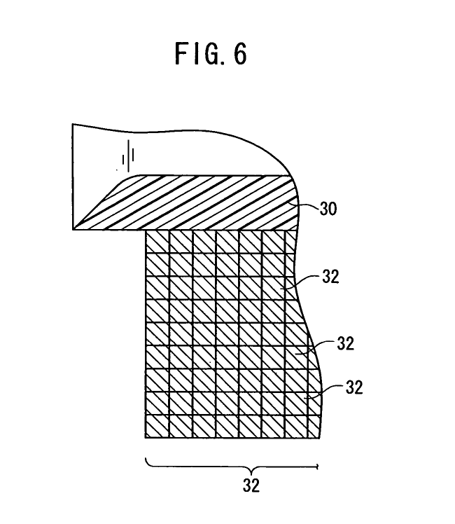

The turns of the coil 32 having a square cross section, which is wound around the coil bobbin 30, are held in surface-to-surface contact with each other. Therefore, the turns of the coil 32 are stably arrayed in desired positions. Since the turns of the coil 32 are thus stably arrayed, one of the flanges 28a or 28b may be dispensed with as shown in FIG. 6. If one of the flanges 28a or 28b is dispensed with, the axial dimension of the solenoid 12 is reduced, thereby making the solenoid 12 smaller in size.

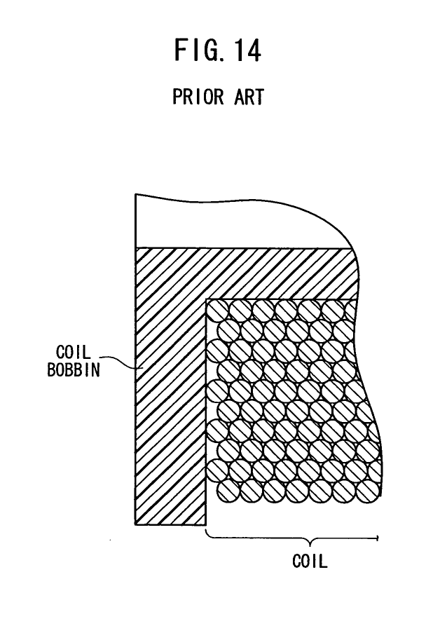

When a conventional coil, comprising a conductive wire having a circular cross section, is wound around a coil bobbin, as shown in FIG. 14, then the coil is subject to forces tending to cause the coil to collapse toward the flange under the tension of the wound coil. The coil 32 having a square cross section, according to the present embodiment, has turns which are held in surface-to-surface contact with each other, and thus the coil is not subject to forces that would tend to cause the coil 32 to collapse toward the flanges 28a, 28b. Consequently, one of the flanges 28a or 28b may be dispensed with, as shown in FIG. 6.

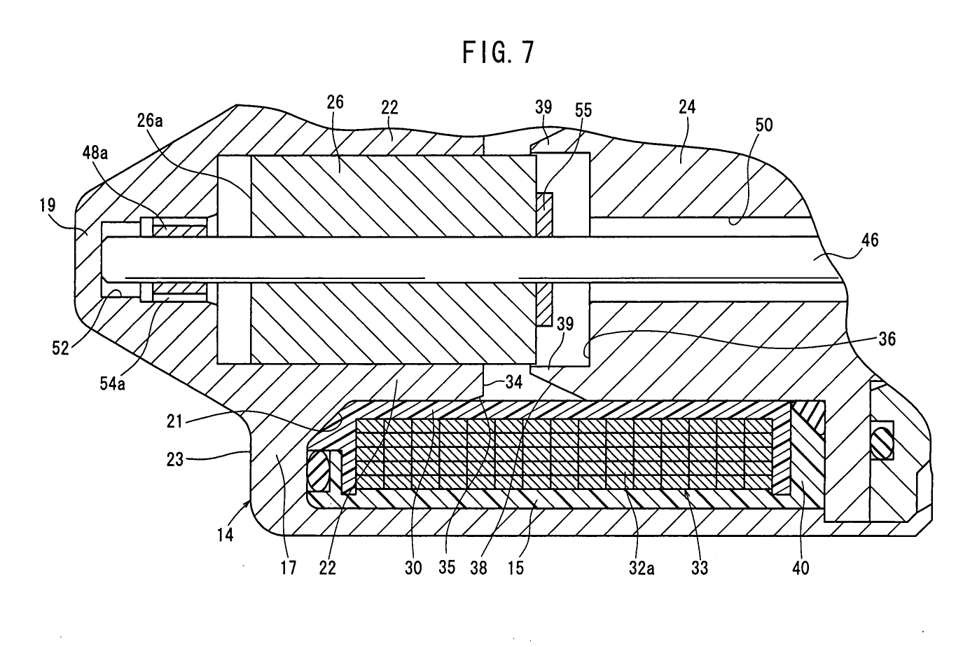

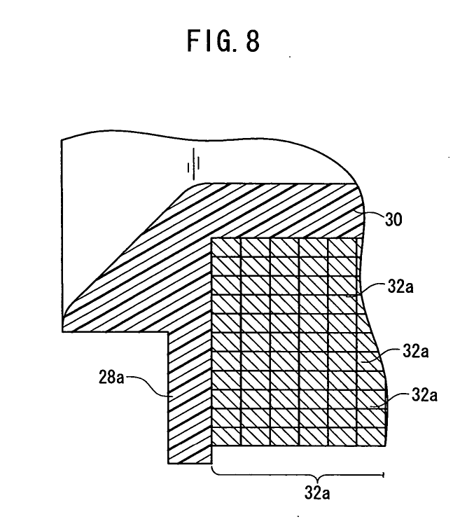

As shown in FIGS. 7 and 8, the solenoid 12 may include a coil 32a comprising a flat conductive wire having an elongate rectangular cross section. However, if the coil 32 has a square cross section, the coil can be wound in a smaller space than is possible with the coil 32a having an elongate rectangular cross section. Furthermore, since the coil 32 having a square cross section provides a smaller cross-sectional circumferential dimension than the coil 32a having an elongate rectangular cross section, the cross-sectional area of an insulating film on the coil 32 may be smaller in value.

The yoke 22 has an annular flat surface 34 on the right end thereof that faces the fixed core 24, and the fixed core 24 has an outer conical surface 38 on the left end thereof that faces the yoke 22. The annular flat surface 34 lies perpendicularly to the axis of the yoke 22, and the outer conical surface 38 extends on the outer circumferential surface of the fixed core 24 around a cavity 36 defined in the fixed core 24. The yoke 22 also has a tapered surface 35 formed on an end face thereof adjacent to the annular flat surface 34, serving as a circumferentially beveled surface for reducing flux leakage.

The tubular yoke 22 and the cavity 36 defined in the fixed core 24 are complementary in shape to the movable core 26, providing a linear solenoid structure in which the movable core 26 is slidable between the tubular yoke 22 and the cavity 36 defined in the fixed core 24.

As shown in FIGS. 3, 4 and 7, an annular flange 39 having a substantially triangular cross section, which is defined between the outer conical surface 38 and the inner cavity 36, is disposed on the end of the fixed core 24 that faces the movable core 26. The annular flange 39 is formed integrally with the end of the fixed core 24 and has a central reference line C, which is located at a position (about L/2) dividing the axial dimension L of the coil stack 33 into substantially equal halves (see FIG. 3).

A synthetic resin sealing body 40, which is molded over the outer circumferential surface of the coil 32 as well as a portion of the coil bobbin 30, is disposed between the housing 14 and the coil 32. The synthetic resin sealing body 40 is molded from a synthetic resin material integrally with a coupler 42. The coupler 42 has a terminal 44 electrically connected to the coil 32 and an exposed terminal end 44a that is electrically connected to a power supply (not shown).

The coil 32 has its outer circumferential surface covered with the synthetic resin sealing body 40 for stable protection of the coil 32. If one of the flanges 28a (28b) on the ends of the coil bobbin 30 is dispensed with, then the portion of the coil bobbin 30 that lacks the flange 28a (28b) is also covered with the synthetic resin sealing body 40 for stable protection of the coil 32.

The shaft 46 extends centrally axially through and is fixed to the movable core 26. The shaft 46 has an end axially and slidably supported by a first plane bearing (first bearing) 48a mounted in the hole 52 provided in the protrusion 19 of the housing 14, and the other end thereof is axially and slidably supported by a second plane bearing (second bearing) 48b mounted in a through hole 50 defined centrally and axially through the fixed core 24.

The movable core 26 has axially opposite ends deformed radially inwardly and crimped onto the shaft 46, and hence the movable core 26 is integrally joined to the shaft 46. The movable core 26 and the shaft 46 need not be separate from each other, but may be formed together integrally.

Since the axially opposite ends of the shaft 46 which extend axially through the movable core 26 are slidably supported respectively by the first and second bearings 48a, 48b, the movable core 26 is supported on a dual-end support structure provided by the shaft 46. The dual-end support structure provided by the shaft 46 allows the movable core 26 to make stable axial linear movement.

The first plane bearing 48a is press-fitted securely in the hole 52 provided in the protrusion 19, and has first communication grooves 54a defined on an outer circumferential surface thereof and communicating between opposite ends thereof. The second plane bearing 48b is press-fitted securely in the through hole 50, and has second communication grooves 54b defined on an outer circumferential surface thereof and communicating between opposite ends thereof.

A ring 55 is mounted on the end face of the movable core 26 that faces the fixed core 24 and is fitted over the shaft 46. The ring 55 is made of a nonmagnetic material and functions as a spacer for preventing residual magnetism from being produced in the solenoid 12.

Specifically, when the solenoid 12 is deenergized, residual magnetism may be produced in the fixed core 24 or in the movable core 26, tending to keep the movable core 26 attracted to the fixed core 24. However, the nonmagnetic ring 55, which is mounted on the end face of the movable core 26 and fitted over the shaft 46, forms a certain clearance between the movable core 26 and the fixed core 24, thereby preventing residual magnetism from being produced.

The movable core 26 may be made of a ferrite-base stainless steel such as SUS410L, SUS405 (JIS) or the like, a general steel such as S10C (JIS) or the like, or a free-cutting steel such as SUM (JIS) or the like.

The valve mechanism 16 comprises the valve body 18 including an inlet port 56, an outlet port 58, a drain port 60, and a breather port 62 communicating with an oil tank (not shown), defined in a side wall thereof, and a spool valve (valve element) 66 axially disposed for displacement within a space 64 defined in the valve body 18.

The spool valve 66 has a first land 66a, a second land 66b and a third land 66c, which are positioned successively from the solenoid 12. The first land 66a and the second land 66b are of the same diameter, and the third land 66c is slightly smaller in diameter than the first land 66a and the second land 66b.

The space 64 within the valve body 18 is closed by an end block 68 disposed in the end of the valve body 18 remote from the solenoid 12. A return spring 70 for normally pressing the spool valve 66 toward the solenoid 12 is disposed between the end block 68 and the spool valve 66. The return spring 70 is illustrated as being a helical spring. However, the return spring 70 is not limited to a helical spring, but may be another resilient member such as a leaf spring or the like.

The spool valve 66 has an end face positioned closely to the solenoid 12 and held in abutting engagement with the end of the shaft 46. The spring force of the return spring 70 acts through the spool valve 66 and the shaft 46 on the movable core 26, pressing the movable core 26 axially in the direction indicated by the arrow X1 in FIG. 1.

The hydraulic control valve 10 according to the present embodiment is basically constructed as described above. Operations and advantages of the hydraulic control valve 10 will be described below.

When the solenoid 12 is deenergized, the spool valve 66 is pressed axially in the direction indicated by the arrow X1 in FIG. 1 under the spring force (pressing force) of the return spring 70, holding the inlet port 56 and the outlet port 58 out of communication with each other.

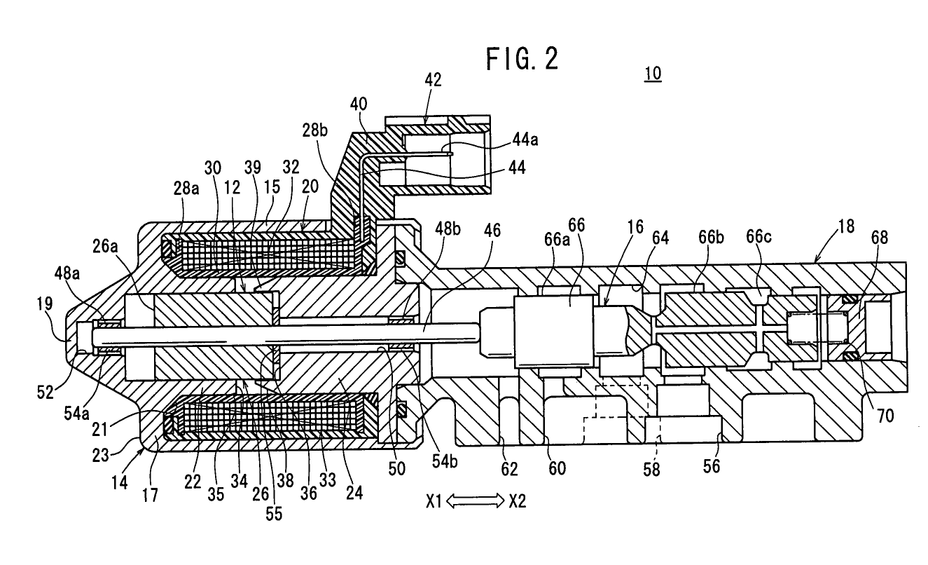

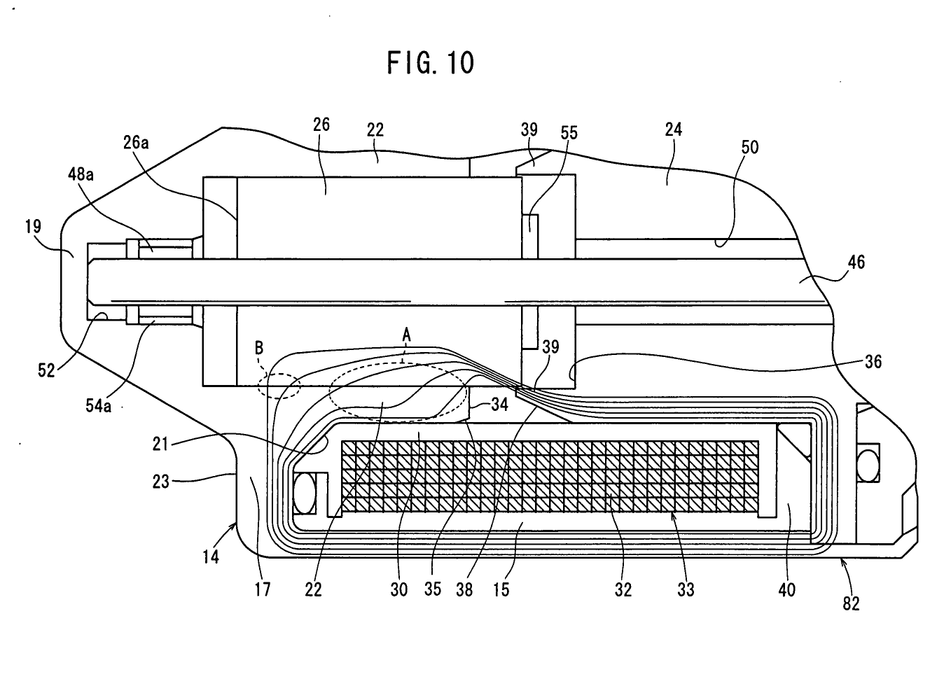

When the non-illustrated power supply is turned on, the coil 32 of the solenoid 12 is energized, forming a magnetic circuit 82 as shown in FIG. 10 that generates an electromagnetic force. At this time, the generated electromagnetic force is proportional to the amount of current supplied to the coil 32, and is applied to the movable core 26. Under the generated electromagnetic force, the shaft 46, and hence the spool valve 66, are axially displaced in the direction indicated by the arrow X2 in FIG. 1 against the bias of the return spring 70. The drain port 60 and the outlet port 58 are brought out of communication with each other, and the inlet port 56 and the outlet port 58 are brought into communication with each other (see FIG. 2).

Oil, which is supplied under pressure from an oil source (not shown) through a passageway (not shown), flows through the inlet port 56 and the outlet port 58 and is supplied to a hydraulic device (not shown). When the solenoid 12 is deenergized, the spool valve 66 returns to the initial position shown in FIG. 1 under the bias of the return spring 70.

In the present embodiment, the central reference line C of the annular flange 39 of the fixed core 24 is located at a position (about L/2) dividing the axial dimension L of the coil stack 33 into substantially equal halves. Therefore, the amount of magnetic flux (magnetic flux amount) flowing through the magnetic circuit 82 is increased, as shown in FIG. 10.

Specifically, the magnetic field intensity is strongest substantially centrally within the coil stack 33, and the annular flange 39, which serves as a magnetically attractive member, is disposed substantially centrally inside of a linear pattern, except corners, of magnetic fluxes circulating around the coil stack 33 having a substantially elongate rectangular cross section. Such features serve to orient the vector of the magnetic fluxes in one direction toward the annular flange 39.

As a result, the annular flange 39 disposed substantially centrally in the axial direction of the coil stack 33 is effective to increase the attractive forces (electromagnetic forces) imposed on the movable core 26. Alternatively, if the solenoid 12 is desired to produce the same attractive forces as a conventional solenoid, then the hydraulic control valve 10 can be reduced in overall size.

According to the present embodiment, when the coil 32 is deenergized, as shown in FIGS. 1 and 3, a portion of a circumferential side surface of the movable core 26, and the bottom 17 of the housing 14 along with a circumferential side surface of the yoke 22 that is contiguous to the bottom 17 are disposed in overlapping positions, i.e., the end face 26a of the movable core 26 and the end face 23 of the housing 14 lie substantially flush with each other.

As shown in FIG. 10, magnetic fluxes generated when the coil 32 is energized include a flow of magnetic fluxes (A in FIG. 10) flowing from the inner circumferential surface of the tubular yoke 22, through the bottom 17 of the housing 14, and toward the circumferential side surface of the movable core 26, and another flow of magnetic fluxes (B in FIG. 10) flowing from a portion of the inner circumferential surface of the tubular yoke 22 that corresponds to the bottom 17, through the bottom 17, and toward the circumferential side surface of the movable core 26.

In the magnetic circuit of a conventional electromagnetic valve, when magnetic fluxes flow through the bottom 17 to the movable core 26, the magnetic fluxes flow through the bottom 17 into the tubular yoke 22, and thereafter flow only in the direction of flow A, from the yoke 22 to the movable core 26. According to the present embodiment, on the other hand, magnetic fluxes flow both in the direction of flow A, from the yoke 22 to the movable core 26, and also in the direction of flow B, from the portion of the inner circumferential surface of the tubular yoke 22 that corresponds to the bottom 17 toward the movable core 26. Therefore, the magnetic fluxes flow highly smoothly, and the amount of overall magnetic flux flowing through the magnetic circuit 82 is increased (including the flow A of magnetic fluxes as well as the flow B of magnetic fluxes).

As a result, the solenoid 12 can produce increased attractive forces. Alternatively, if the solenoid 12 is desired to produce the same attractive forces as a conventional solenoid, then the hydraulic control valve 10 can be reduced in overall size.

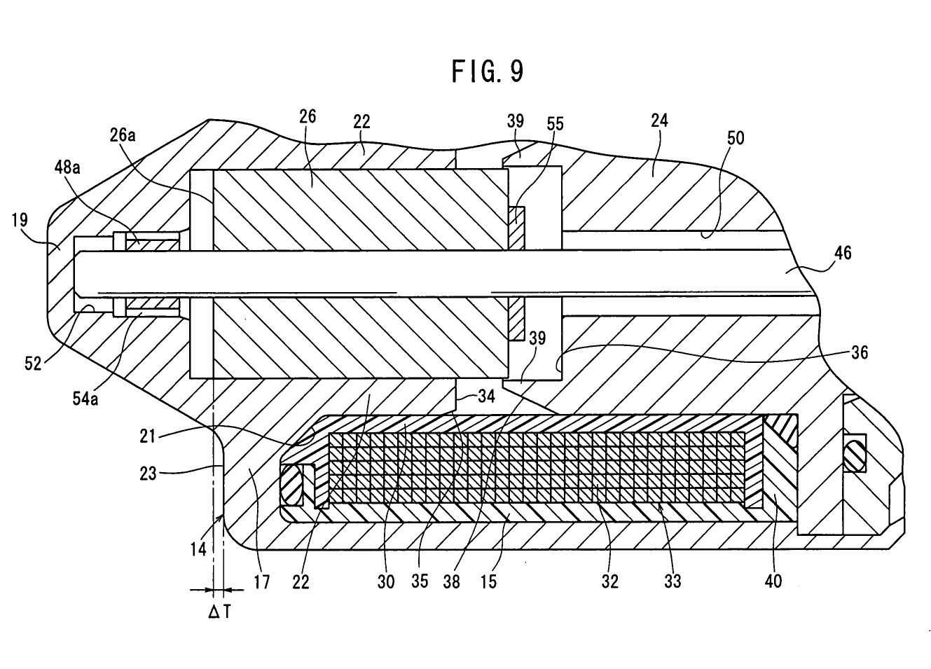

The end face 26a of the movable core 26 and the end face 23 of the housing 14 are not required to lie flush with each other. According to the modification shown in FIG. 9, the end face 26a of the movable core 26 projects a distance ΔT outwardly (toward the protrusion 19) beyond the end face 23 of the housing 14. This structure is effective to increase the amount of magnetic flux flowing from the portion of the inner circumferential surface of the tubular yoke 22 that corresponds to the bottom 17 to the movable core 26.

In the present embodiment, the tapered portion 21 which is progressively smaller in diameter from the bottom 17 toward the yoke 22, or the rounded portion 21a of arcuate cross section, which is disposed on the inner wall of the housing 14 across which the outer hollow cylindrical member 15 and the inner yoke 22 radially confront each other, allows the magnetic fluxes to flow more smoothly through the bottom 17 of the housing 14 toward the movable core 26, thus resulting in an increased amount of magnetic flux.

Specifically, since the joint (the inner surface of the joint region) between the tubular yoke 22 and the bottom 17 of the housing 14 is tapered or rounded toward the movable core 26, the flow of circulating magnetic fluxes, which is generated by the coil stack 33 having an elongate rectangular cross section, is considered to have a more ideal configuration.

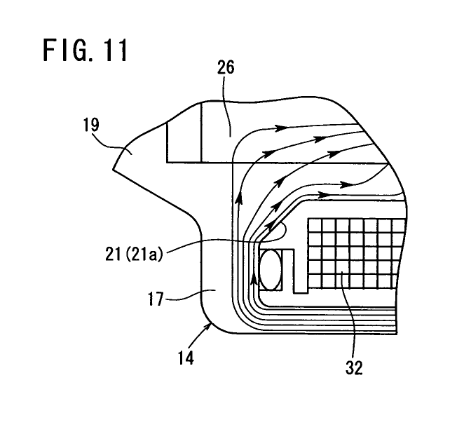

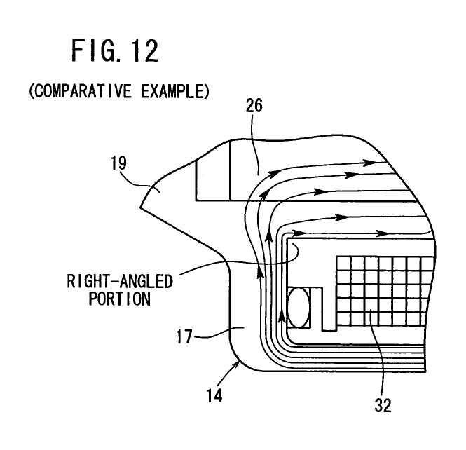

For example, according to the comparative example shown in FIG. 12, in which a right-angled portion or corner is formed on an inner surface of the joint between the yoke 22 and the bottom 17 of the housing 14, magnetic fluxes flow toward the protrusion 19 and thus do not flow smoothly. According to the present embodiment, as shown in FIG. 11, magnetic fluxes flowing from the bottom 17 through the tapered portion 21 (the rounded portion 21a) flow smoothly toward the yoke 22.

In the vicinity of the tapered portion 21 or the rounded portion 21a, a magnetic flux vector is oriented in one direction toward the movable core 26, to and from which the magnetic fluxes are transferred. Consequently, magnetic fluxes flow more smoothly toward the movable core 26, resulting in an increased amount of flowing magnetic flux.

Furthermore, since the tapered portion 21 or the rounded portion 21a increases the area of the inner circumferential surface of the bottom 17, which corresponds to the circumferential side surface of the movable core 26, the area of the magnetic path is increased, also resulting in an increased amount of flowing magnetic flux.

As a result, the solenoid 12 can increase the attractive force imposed on the movable core 26. Alternatively, if the solenoid 12 is desired to produce the same attractive force as a conventional solenoid, then the hydraulic control valve 10 can be reduced in overall size.

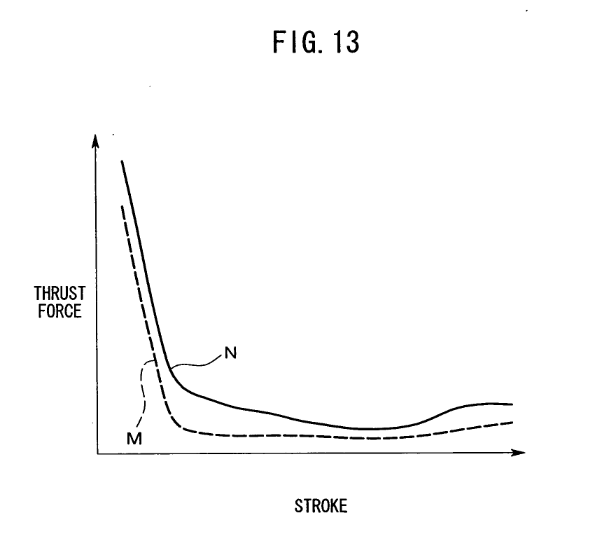

FIG. 13 shows the relationship between the thrust force on the movable core 26 and the stroke thereof. It can be seen from FIG. 13 that the thrust force generated when the tapered portion 21 is present, as indicated by a characteristic curve N shown by the solid line, is greater than the thrust force generated when the tapered portion 21 is not present, as indicated by a characteristic curve M shown by the broken line.

In addition, in the present embodiment the coil 32, which is wound around the coil bobbin 30 of the solenoid 12, is of a square or elongate rectangular cross section, thereby minimizing gaps between stacked turns of the coil 32. Therefore, the total cross-sectional area of the coil 32, i.e., the overall space occupied by the coil 32 wound around the coil bobbin 30, is smaller than in a conventional solenoid coil having a circular cross section with the same number of turns as the coil 32.

Stated otherwise, the ratio of the cross-sectional area of the conductor of the coil 32 to the space in which the coil 32 is wound, i.e., the conductor occupation ratio, may be greater than that of a solenoid coil having a circular cross section. Since the space in which the coil 32 is wound can be reduced, the coil bobbin 30 can be reduced in size, resulting in a reduction in overall size of the solenoid 12.

If the space in which the coil 32 is wound is made the same as the space in which a solenoid coil having a circular cross section is wound, then the number of turns of the coil 32 having a square cross section on the coil bobbin 30 can be greater than the number of turns in a solenoid coil having a circular cross section. Accordingly, the solenoid 12 can produce greater attractive forces (electromagnetic forces) than is possible in a solenoid coil having a circular cross section.

In the present embodiment, since the space in which the coil 32 is wound can be reduced, the total dimension (total length) of the continuous wire of the coil 32 can be reduced, and hence the resistance of the coil 32 can also be reduced. As a result, the electric power consumed when the coil 32 is energized can be reduced.

Alternatively, if the coil 32 having a square cross section is desired to have the same resistance as a solenoid coil having a circular cross section, then the number of turns of the coil 32 wound around the coil bobbin 30 can be increased in the present embodiment, thereby producing increased attractive forces (electromagnetic forces).

In the present embodiment, since the coil 32 having a square cross section has turns that are held in surface-to-surface contact with each other, the conductor occupation ratio within the space in which the coil 32 is wound is greater than would be possible if a coil having a circular cross section were wound within the same space.

Consequently, gaps between stacked turns of the coil 32 can be minimized, thus increasing the density of turns of the coil 32 per unit volume within the space in which the coil 32 is wound. As a result, the heat transfer capability (heat radiation capability) within the space in which the coil 32 is wound can also be increased. If the present invention is applied to an electromagnetic valve for use in an environment where the atmospheric temperature is lower than the temperature to which the coil is heated, then since the heat radiation capability can be increased along with reducing the resistance of the coil 32, the amount of heat generated by the coil 32 when it is energized is reduced. Therefore, the resistance of the coil 32 can further be reduced.

The solenoid 12 including the coil having a square cross section can be used in an electromagnetic valve for use in vehicles. Generally, there is a minimum battery voltage of 8V, for example, which is applied to electric parts for use in vehicles. Since electromagnetic valves for use in vehicles are required to maintain a minimum magnetomotive force (current value), the maximum resistance that such electromagnetic valves should have is necessarily determined if the same magnetic circuit is employed. Because resistance of the coil 32 generally increases as the temperature thereof increases, the maximum resistance must be of a value that takes into account such a temperature-dependent resistance increase. If the maximum resistance is set without taking into account the temperature-dependent resistance increase, then the electromagnetic valve may not receive the required current, and thus possibly, the electromagnetic valve may not produce the required minimum magnetomotive force. Therefore, if the solenoid 12 is used in an electromagnetic valve for use in vehicles, then a desired magnetomotive force (current value) must be maintained, even though the resistance of the coil 32 may increase due to an increase in the temperature of the coil 32 when the solenoid 12 is energized.

It is highly advantageous if the resistance of the coil 32 itself, as well as the resistance of the coil 32 when it is heated upon energization, are kept low, because in this case the coil 32 can maintain a high current value according to Ohm's law. With the coil 32 having a square cross section, the solenoid 12 can produce the same magnetomotive force as conventional solenoids, yet the resistance of the coil 32 is made smaller and the coil 32 consumes a lower amount of electric power, thus reducing the amount of heat generated by the coil 32 when it is energized, and resulting in a reduction in the resistance of the coil 32 during times when the coil 32 is energized and heated.

As a result, the resistance of the coil 32 during times when it is energized and heated can be reduced, thereby allowing an increased current to pass through the coil 32. Therefore, the solenoid 12 can appropriately be used in an electromagnetic valve for which a minimum applied voltage is limited. Furthermore, since the current value of the solenoid 12, which includes a coil 32 having a square cross section, is higher than in conventional solenoids having a coil of circular cross section, while producing the same minimum magnetomotive force, the number of turns of the coil 32 wound around the coil bobbin 30 can be smaller, and hence the coil 32 can be made smaller in size.

Although certain preferred embodiments of the present invention have been shown and described in detail, it should be understood that various changes and modifications may be made therein without departing from the scope of the appended claims.

1. A linear solenoid valve for generating an electromagnetic force in proportion to an amount of current supplied to a solenoid and displacing a valve element under the generated electromagnetic force, comprising:
a valve casing including a valve body having an inlet port and an outlet port for passage of a fluid under pressure therethrough, and a housing joined to said valve body;
a solenoid mounted in said housing and having a coil wound around a coil bobbin, a fixed core, a movable core that is attracted to said fixed core when said coil is energized, and a tubular yoke surrounding said movable core; and
a valve mechanism mounted in said valve body and having a valve element responsive to displacement of said movable core for selectively bringing said inlet port and said outlet port into and out of fluid communication with each other,
wherein said movable core has an end face facing said housing, and said housing has an outer end face, said end face and said outer end face lying substantially flush with each other.

2. A linear solenoid valve according to claim 1, wherein said housing includes a bottom having said outer end face, and a tapered portion disposed in an inner wall region by which said bottom and said yoke are joined to each other, said tapered portion being progressively smaller in diameter from said bottom toward said yoke.

3. A linear solenoid valve according to claim 1, wherein said housing includes a bottom having said outer end face, and a rounded portion of arcuate cross section disposed in an inner wall region by which said bottom and said yoke are joined to each other.

4. A linear solenoid valve according to claim 1, wherein said fixed core has an annular flange disposed on an end thereof which confronts said movable core and defined between an outer conical surface of said fixed core and an inner cavity defined in said fixed core, said annular flange being disposed substantially centrally in an axial direction of a coil stack which comprises stacked coil layers of said coil on said bobbin.

5. A linear solenoid valve according to claim 1, wherein said solenoid further includes a shaft extending axially through and fixed to said movable core for displacement in unison with said movable core, said shaft having an end slidably supported by a first bearing disposed in said housing and an opposite end slidably supported by a second bearing mounted in said fixed core.

6. A linear solenoid valve according to claim 1, wherein said coil comprises a wire having a square cross section.

7. A linear solenoid valve according to claim 1, wherein said coil comprises a wire having an elongate rectangular cross section.

8. A linear solenoid valve for generating an electromagnetic force in proportion to an amount of current supplied to a solenoid and displacing a valve element under the generated electromagnetic force, comprising:
a valve casing including a valve body having an inlet port and an outlet port for passage of a fluid under pressure therethrough, and a housing joined to said valve body;
a solenoid mounted in said housing and having a coil wound around a coil bobbin, a fixed core, a movable core that is attracted to said fixed core when said coil is energized, and a tubular yoke surrounding said movable core; and
a valve mechanism mounted in said valve body and having a valve element responsive to displacement of said movable core for selectively bringing said inlet port and said outlet port into and out of fluid communication with each other,
wherein said movable core has an end face facing said housing, and said housing has an outer end face, said end face projecting outwardly beyond said outer end face.

9. A linear solenoid valve according to claim 8, wherein said end face of the movable core projects a predetermined distance beyond said outer end face toward a protrusion disposed on said housing.

10. A linear solenoid valve for generating an electromagnetic force in proportion to an amount of current supplied to a solenoid and displacing a valve element under the generated electromagnetic force, comprising:
a valve casing including a valve body having an inlet port and an outlet port for passage of a fluid under pressure therethrough, and a housing joined to said valve body;
a solenoid mounted in said housing and having a coil stack which comprises stacked coil layers of a coil wound around said bobbin, a fixed core, a movable core that is attracted to said fixed core when said coil is energized, and a tubular yoke surrounding said movable core; and
a valve mechanism mounted in said valve body and having a valve element responsive to displacement of said movable core for selectively bringing said inlet port and said outlet port into and out of fluid communication with each other,
wherein said fixed core has an annular flange disposed on an end thereof which confronts said movable core and defined between an outer conical surface of said fixed core and an inner cavity defined in said fixed core, said annular flange being disposed substantially centrally in an axial direction of said coil stack.

11. A linear solenoid valve according to claim 10, wherein said movable core has an end face facing said housing, and said housing has an outer end face, said end face and said outer end face lying substantially flush with each other.

12. A linear solenoid valve according to claim 11, wherein said housing includes a bottom having said outer end face, and a tapered portion disposed in an inner wall region by which said bottom and said yoke are joined to each other, said tapered portion being progressively smaller in diameter from said bottom toward said yoke.

13. A linear solenoid valve according to claim 11, wherein said housing includes a bottom having said outer end face, and a rounded portion of arcuate cross section disposed in an inner wall region by which said bottom and said yoke are joined to each other.

14. A linear solenoid valve according to claim 10, wherein said movable core has an end face facing said housing, and said housing has an outer end face, said end face projecting outwardly beyond said outer end face.

15. A linear solenoid valve according to claim 14, wherein said housing includes a bottom having said outer end face, and a tapered portion disposed in an inner wall region by which said bottom and said yoke are joined to each other, said tapered portion being progressively smaller in diameter from said bottom toward said yoke.

16. A linear solenoid valve according to claim 14, wherein said housing includes a bottom having said outer end face, and a rounded portion of arcuate cross section disposed in an inner wall region by which said bottom and said yoke are joined to each other.

17. A linear solenoid valve according to claim 10, wherein said solenoid further includes a shaft extending axially through and fixed to said movable core for displacement in unison with said movable core, said shaft having an end slidably supported by a first bearing disposed in said housing and an opposite end slidably supported by a second bearing mounted in said fixed core.

18. A linear solenoid valve according to claim 10, wherein said coil comprises a wire having a square cross section.

19. A linear solenoid valve according to claim 10, wherein said coil comprises a wire having an elongate rectangular cross section.
